(19) United States
(12) Patent Application Publication
(10) Pub. No.: US 2009/0116164 A1
(43) Pub. Date: May 7, 2009

(54) Lighting device having electrostatic discharge unit

(75) Inventors: Kuo-Hsin Teng, Taipei (TW); Hon-Lun Chen, Taipei (TW); Cai-Nan Lee, Taipei (TW); Jyh-Way Wu, Taipei (TW); Ching-Yuan Huang, Taipei (TW)

Correspondence Address: REED SMITH LLP, Suite 1400, 3110 Fairview Park Drive, Falls Church, VA, 22042, US

(73) Assignee: PRODISC TECHNOLOGY INC.

(21) Appl. No.: 12/010,980

(22) Filed: Jan. 31, 2008

(30) Foreign Application Priority Data
Nov. 5, 2007 (TW) 096141625

(51) Int. Cl. H01H 51/27

(52) U.S. Cl. 361/220

(57) ABSTRACT

A lighting device having an electrostatic discharge unit is provided. The lighting device having the electrostatic discharge unit comprises a lighting unit and the electrostatic discharge unit. The lighting unit comprises a first metal shell, wherein the first metal shell comprises a first opening. The electrostatic discharge unit is installed in the first opening. To prevent the user from getting an electric shock due to any static electricity, the static electricity on the user's body portions, such as hands, can be discharged by the electrostatic discharge unit before the user turns the lighting unit on or controls the same. According to the present invention, the electrostatic discharge unit is directly combined on the lighting unit to provide timely use for the user and improve the practicability and the convenience property of the electrostatic discharge unit.

### BACKGROUND OF THE INVENTION

1. Field of the Invention

The present invention relates to a lighting device, and especially relates to a lighting device having an electrostatic discharge unit.

2. Descriptions of the Related Art

In people's daily life, due to climatical dryness, temperature and humidity or personal constitution, people usually get an electric shock due to static electricity when touching objects. The static electricity is mainly generated from the contact and the separation of two different substances. When two substances touch each other, electrons move from one side to the other; and when the two substances are separated, the one where the electrons left is positively charged and the other where the electrons move to is negatively charged. That's why people get an electric shock due to static electricity when touching objects.

For example, when using a one-touch lighting device, which has a metal external shell, users have to touch the metal external shell by their hands to turn on/off the lighting device or adjust the brightness intensity of the lighting device. If the users' hands are contrary charged as compared with the metal shell, they will get an electric shock due to static electricity as controlling the lighting device by their hands.

To prevent people from the persecution of getting an electric shock due to the static electricity, an electrostatic discharge device is disclosed in Taiwan Utility Patent No. 280,072. The electrostatic discharge device comprises an insulating base, a cover, a conductor and a light emitting element. According to the patent invention, the static electricity accumulated on the surface of the object is conducted to the light emitting element so that the light emitting element turns into bright because of the static electricity. The known electrostatic discharge device is small and easy to carry. However, it can not be timely used if the electrostatic discharge device is forgotten to be carried. Therefore, users may still probably get an electric shock due to static electricity.

### SUMMARY OF THE INVENTION

The present invention relates to a lighting device having an electrostatic discharge unit. The electrostatic discharge unit is directly combined on a lighting unit, so that the electric charges carried on the user's hands can be timely discharged by using the electrostatic discharge unit. This prevents the user from getting an electric shock due to any static electricity when operating the lighting unit.

To achieve the objective above mentioned, the present invention provides a lighting device having an electrostatic discharge unit, comprising: a lighting unit, which comprises a first metal shell, wherein the first metal shell has a first opening; and an electrostatic discharge unit, which is installed in the first opening, comprising: a second metal shell, which is combined with the first metal shell to form an integrated surface, wherein the second metal shell has a second opening; an insulating layer, which is installed around external sides of the second metal shell and between the first and the second metal shells; and an electrostatic discharge circuit, which comprises: an indicator light installed in the second opening, wherein one end of the indicator light is electrically connected with the second metal shell; and a resistance, wherein one end of the resistance is electrically connected with an opposite end of the indicator light and an opposite end of the resistance is electrically connected with a ground end.

To achieve the objective above mentioned, the present invention further provides an electrostatic discharge unit, comprising: a second metal shell, which comprises a second opening; an insulating layer, installed around the external sides of the second metal shell; and an electrostatic discharge circuit, which comprises: an indicator light installed in the second opening, wherein one end of the indicator light is electrically connected with the second metal shell; and a resistance, wherein one end of the resistance is electrically connected with an opposite end of the indicator light and an opposite end of the resistance is electrically connected with a ground end.

At least following effects can be achieved by the present invention:

1. The convenience property for use of the electrostatic discharge unit is improved by directly installing the electrostatic discharge unit on the lighting unit.

2. The electrostatic discharge unit can be installed on any other device, as a result, the practicability of the electrostatic discharge unit is improved.

The detailed features and advantages of the present invention are concretely illustrated in the description of the preferred embodiment, so that people skilled in the field of the invention can easily realize the characteristics of the invention and carry it out. According to the disclosed contents, claims and figures, people skilled in the field of the invention can easily understand the objectives and advantages of the present invention.

### BRIEF DESCRIPTION OF THE DRAWINGS

FIG. 1A is a perspective view of one embodiment of one lighting device having an electrostatic discharge unit according to the invention;

FIG. 1B is a perspective view of another embodiment of the lighting device having the electrostatic discharge unit according to the invention;

FIG. 2 is a schematic drawing showing one embodiment of the electrostatic discharge unit according to the invention;

FIG. 3 is a sectional chart showing a combination of a first metal shell, an insulating layer and a second metal shell according to the invention; and

FIG. 4 is a schematic drawing showing another embodiment of the electrostatic discharge unit according to the invention.

### DESCRIPTION OF THE PREFERRED EMBODIMENT

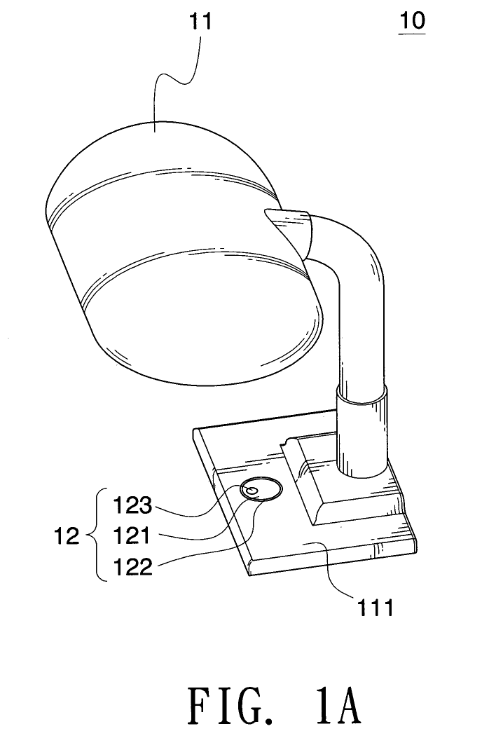

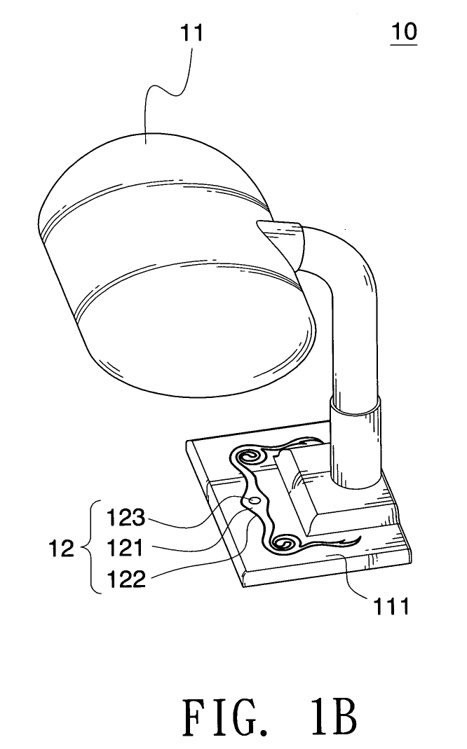

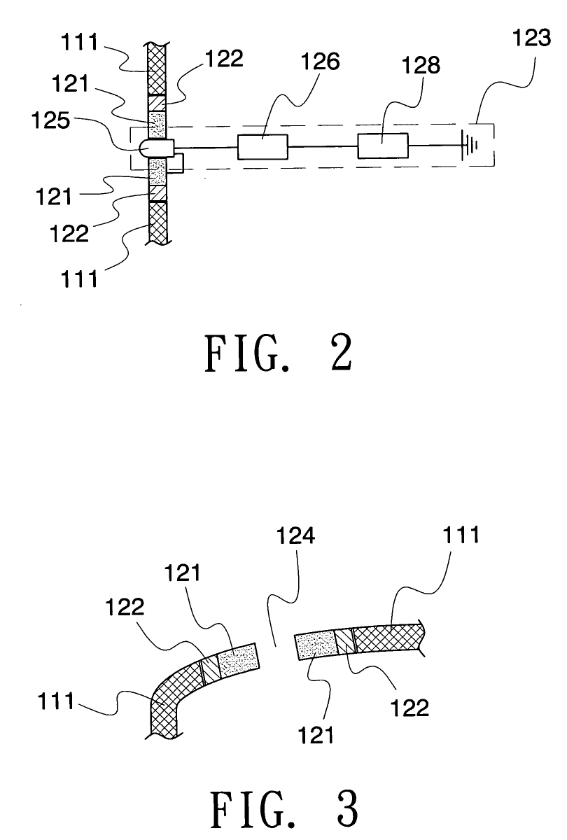

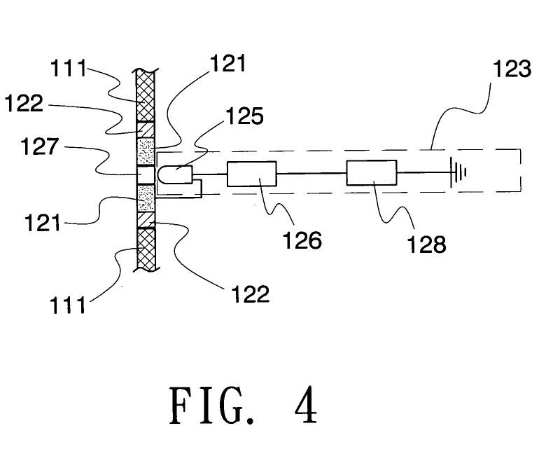

FIG. 1A is a perspective view of one embodiment of one lighting device 10 having an electrostatic discharge unit according to the invention. FIG. 1B is a perspective view of another embodiment of the lighting device 10 having the electrostatic discharge unit according to the invention. FIG. 2 is a schematic drawing showing one embodiment of the electrostatic discharge unit 12 according to the invention. FIG. 3 is a sectional chart showing a combination of a first metal shell 111, an insulating layer 122 and a second metal shell 121 according to the invention. FIG. 4 is a schematic drawing showing another embodiment of the electrostatic discharge unit 12 according to the invention.

As shown in FIGS. 1A and 1B, the lighting device 10 having the electrostatic discharge unit comprises a lighting unit 11 and an electrostatic discharge unit 12.

The lighting unit 11, which comprises a first metal shell 111, can be a one-touch lighting desk lamp. The controlling circuit of the lighting unit 11 is operated by using the human body portions (such as fingers) to touch the first metal shell 111 to, for example, turn on/off the lighting unit 11 or to adjust the intensity of the brightness. The first metal shell 111 further comprises a first opening for holding the electrostatic discharge unit 12.

As shown in FIGS. 1A and 1B, the electrostatic discharge unit 12 comprises a second metal shell 121, an insulating layer 122 and an electrostatic discharge circuit 123. The electrostatic discharge unit 12 is installed in the first opening of the first metal shell 111. The electrostatic discharge unit 12 can be installed anywhere of the lighting unit 11 to let users easily know the position of the electrostatic discharge unit 12. As shown in FIG. 1B, the electrostatic discharge unit 12 can also be a designed pattern to embellish the lighting device 10. This also can increase the area of the second metal shell 121 to facilitate users' use.

As shown in FIGS. 2 and 3, the second metal shell 121 is combined with the first metal shell 111 to form an integrated surface. The second metal shell 121 comprises a second opening 124 where the electrostatic discharge circuit 123 can be installed. By touching the second metal shell 121, the electric charges on human body portions (such as fingers) can be discharged through the electrostatic discharge circuit 123.

The insulating layer 122 is installed around the external sides of the second metal shell 121 and between the second metal shell 121 and the first metal shell 111 so that the first metal shell 111 and the second metal shell 121 can be insulated. This prevents users from misoperating the controlling circuit of the lighting unit 11 when touching the second metal shell 121.

As shown in FIG. 2, the electrostatic discharge circuit 123 comprises an indicator light 125 and a resistance 126.

The indicator light 125 can be a light emitting diode. The indicator light 125 is installed in the second opening 124 of the second metal shell 121 and can be exposed out of the second opening 124. This facilitates users' observing whether the indicator light 125 is bright or dark. As shown in FIG. 4, to increase the airtightness of the electrostatic discharge unit 12 and to prevent dust from getting into the electrostatic discharge unit 12 through the chink between the indicator light 125 and the second opening 124, the electrostatic discharge unit 12 can further comprise a light transmitting element 127. The light transmitting element 127 is combined in the second opening 124 and forms an integrated surface with the second metal shell 121. In this case, the indicator light 125 can be installed in one lateral surface of the light transmitting element 127 so that users can observe whether the indicator light 125 is bright or dark through the light transmitting element 127.

As shown in FIGS. 2 and 4, one end of the indicator light 125 is electrically connected with the second metal shell 121. One end of the resistance 126 is electrically connected with the other end of the indicator light 125 and an opposite end of the resistance 126 is electrically connected with a ground end. Besides, the electrostatic discharge circuit 123 can further comprise a capacitor 128, which can be connected in series between the indicator light 125 and the ground end. That is to say, the capacitor 128 can be connected in series or parallel with the resistance 126 to improve the efficiency of the electrostatic discharge circuit 123.

When operating the lighting unit 11, users first touch the second metal shell 121 of the electrostatic discharge unit 12 and the electric charges carried by human body portions (such as fingers) are then conducted to the indicator light 125 (the indicator light 125 shines thereby). The rest charges turn into be a slight current after passing through the resistance 126 and the capacitor 128 and then conducted to the ground end. As a result, the electric charges are discharged and this prevents users from getting an electric shock caused by static electricity.

Consequently, users can confirm that if the electric charges carried on hands are completely discharged by observing whether the indicator light 125 is bright or dark. When indicator light 125 is bright, it means that the electrostatic discharge unit 12 is operating; and if the indicator light 125 is dark, it means that the electrostatic discharge job is done. When the indicator light 125 completely turns into dark, users can take their ease to touch the lighting unit 11 to turn on/off which or to adjust the brightness intensity of which.

The electrostatic discharge unit 12 of the embodiment is not merely used to be applied on the lighting unit 11, but can be also variously installed in any device or any equipment to discharge static electricity and to avoid users from getting an electric shock due to the static electricity. Besides, the practicability of the electrostatic discharge unit 12 is improved since it is combined within the device used.

The above examples are intended for illustrating the embodiments of the subject invention and the technical features thereof so that people skilled in the field of the invention can easily realize the characteristics of the invention and carry it out, but not for restricting the scope of protection of the subject invention. Any modification or equivalent arrangements, which can be easily accomplished by people skilled in this field are within the scope of the subject invention. The scope of the subject invention is based on the claims as appended.

What is claimed is:

1. A lighting device having an electrostatic discharge unit, comprising:
a lighting unit, which comprises a first metal shell, wherein the first metal shell has a first opening; and
an electrostatic discharge unit, which is installed in the first opening, comprising:
a second metal shell, which is combined with the first metal shell to form an integrated surface, wherein the second metal shell has a second opening;
an insulating layer, installed around external sides of the second metal shell and between the first and the second metal shells; and
an electrostatic discharge circuit, which comprises:
an indicator light installed in the second opening, wherein one end of the indicator light is electrically connected with the second metal shell; and
a resistance, wherein one end of the resistance is electrically connected with an opposite end of the indicator light and an opposite end of the resistance is electrically connected with a ground end.

2. The lighting device as claimed in claim 1, wherein the indicator light is a light emitting diode.

3. The lighting device as claimed in claim 1, which further comprises a light transmitting element combined in the second opening, wherein the indicator light is installed in one lateral surface of the light transmitting element.

4. The lighting device as claimed in claim 1, which further comprises a capacitor, wherein the capacitor is connected in series between the indicator light and the ground end.

5. An electrostatic discharge unit, comprising:
a second metal shell, comprising a second opening;
an insulating layer, installed around external sides of the second metal shell; and
an electrostatic discharge circuit, which comprises:
an indicator light, installed in the second opening, wherein one end of the indicator light is electrically connected with the second metal shell; and
a resistance, wherein one end of the resistance is electrically connected with an opposite end of the indicator light and an opposite end of the resistance is electrically connected with a ground end.

6. The lighting device as claimed in claim 5, wherein the indicator light is a light emitting diode.

7. The lighting device as claimed in claim 5, which further comprises a light transmitting element combined in the second opening, wherein the indicator light is installed in one lateral surface of the light transmitting element.

8. The lighting device as claimed in claim 5, which further comprises a capacitor, wherein the capacitor is connected in series between the indicator light and the ground end.
